(19) United States
(12) Patent Application Publication
(10) Pub. No.: US 2007/0092003 A1
(43) Pub. Date: Apr. 26, 2007

(54) METHOD AND APPARATUS FOR CALCULATING COST FUNCTIONS AND INTERPOLATION METHOD THEREOF

(76) Inventor: Chao-Tsung Huang, Kaohsiung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,561

(22) Filed: Jan. 3, 2006

(30) Foreign Application Priority Data
Oct. 25, 2005 (TW) 94137242

(51) Int. Cl. H04N 7/12; H04B 1/66

(52) U.S. Cl. 375/240.12; 375/240.29

(57) ABSTRACT

An interpolation method for decimal motion estimation and a method and apparatus for calculating cost functions derived from the interpolation method are provided. The interpolation method comprises the following steps. First, divide the data range needed by an interpolation filtering process into a loaded range and a speculation range. Load the data in the loaded range and then generate the data in the speculation range based on the data in the loaded range. Finally, use the data range as input data to perform the interpolation filtering process.

### CROSS-REFERENCE TO RELATED APPLICATION

This application claims the priority benefit of Taiwan application serial no. 94137242, filed on Oct. 25, 2005. All disclosure of the Taiwan application is incorporated herein by reference.

### BACKGROUND OF THE INVENTION

1. Field of the Invention

The present invention relates to an interpolation method for motion estimation and a method and apparatus for calculating cost functions. More particularly, the present invention relates to an interpolation method and a method and apparatus for calculating cost functions suitable for decimal motion estimation.

2. Description of the Related Art

In video compression and encoding, motion estimation mainly involves calculating and comparing the cost functions of motion vectors within a definite range. The earlier techniques of decimal motion estimation can be divided into two major types. The first method includes, for motion vectors at decimal locations, performing an interpolation filtering on a reference frame to obtain prediction signals of the decimal point locations. Then, a comparison between the prediction signals and an original frame is carried out to generate cost functions. However, this method requires an interpolation filtering computation. Furthermore, to perform the interpolation filtering properly, data much more than the original block must be loaded to provide data for interpolation filtering at the edge of the block.

For example, FIG. 1 is a diagram showing a prior technique of interpolation filtering. As shown in FIG. 1, to generate a reference block 101 for a right down (2.5, 2.5) motion vector for a current block having a 4×4 extension, data much more than the 4×4 block must be loaded. If the interpolation filter has a length of 4, data in an 7×7 integer block (indicated by small blocks in FIG. 1) centered at the motion vector must be loaded. Then, the loaded data must be interpolated to obtain a decimal point location signal (indicated by crosses in FIG. 1). The cost function is derived based on a comparative computation between the interpolated signal and the current block.

One major drawback for this method is that more data than the original block must be loaded to generate the reference block for the decimal point location. As a result, there will be an increase in the memory bandwidth. For the example in FIG. 1, the 7×7 block has a memory bandwidth roughly three times that of the original 4×4 block. Moreover, the memory bandwidth will increase along with the length of the interpolation filter. In addition, to support variable block motion estimation, the ratio of the amount of loaded data to the block size will increase as the block size decreases. Consequently, the increase of the memory bandwidth is even more dramatic.

The second conventional decimal motion estimation method is similar to the method disclosed in U.S. Pat. No. 5,623,313 and 5,694,179. Through the cost function obtained from an integral point motion vector, a speculated cost function of the decimal point motion vector is obtained. This method can significantly reduce the amount of interpolation computation and memory bandwidth. However, the speculated cost function is not very accurate and hence may severely detriment the compression quality.

In other words, the prior techniques can hardly provide a low memory bandwidth and a high compression quality simultaneously.

### SUMMARY OF THE INVENTION

Accordingly, at least one objective of the present invention is to provide an interpolation method suitable for decimal motion estimation that can reduce the memory bandwidth needed for interpolation filtering.

At least another objective of the present invention is to provide a method and an apparatus for calculating cost functions, in particular, suitable for decimal motion estimation such that the memory bandwidth needed for interpolation filtering can be reduced. Furthermore, a higher cost function accuracy and compression quality can be provided.

To achieve these and other advantages and in accordance with the purpose of the invention, as embodied and broadly described herein, the invention provides an interpolation method suitable for decimal motion estimation. The interpolation method includes the following steps. First, (a) divide the data range needed by an interpolation filtering process into a loaded range and a speculation range. (b) Load the data in the loaded range and then (c) generate the data in the speculation range based on the data in the loaded range. Finally, (d) perform the interpolation filtering process using the data range as the input data.

In one embodiment of the aforementioned interpolation method, the loaded range is greater than the corresponding current block of the interpolation filtering process and is smaller than the data range.

In one embodiment of the interpolation method, the step (c) includes directly using the data in the loaded range to fill up the speculation range.

In one embodiment of the interpolation method, for each location inside the speculation range, step (c) includes using the data within the loaded range closest to the aforementioned location to fill up that location.

From another perspective, the present invention also provides a method of calculating cost functions suitable for decimal motion estimation. The cost function calculation includes all the foregoing steps in the interpolation method and the following additional step: (e) compare a current block corresponding to the interpolation filtering process with a reference frame signal produced in step (d) to calculate a cost function.

From another perspective, the present invention also provides a cost function calculation apparatus suitable for decimal motion estimation. The apparatus includes an interpolation unit and a calculation unit. The data range needed for interpolation filtering is divided into a loaded range and a speculation range. The data within the loaded range is loaded. Then, using the data from the loaded range, the data within the speculation range is produced. Finally, using the data range as the input data, an interpolation filtering is carried out. The calculation unit compares the current block corresponding to the interpolation filtering with reference frame signal generated by the interpolation filtering to calculate the cost function.

One critical aspect of the present invention is that only part instead of all the data needed for interpolation filtering process is loaded. Then, using the loaded portion of the data to generate the remaining portion of the data. Because less data is loaded, the memory bandwidth needed to perform the interpolation filtering can be reduced. In addition, most of the data in the interpolation filtering process is still the original reference frame data. As a result, the present invention can also provide an accurate cost function and produce a high compression quality.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing a prior technique of interpolation filtering.

FIG. 2 is a diagram showing an interpolation method according to one embodiment of the present invention.

FIG. 3 is a flowchart showing an interpolation method and a method of calculating a cost function according to one embodiment of the present invention.

FIG. 4 is a block diagram of a cost function calculation apparatus according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

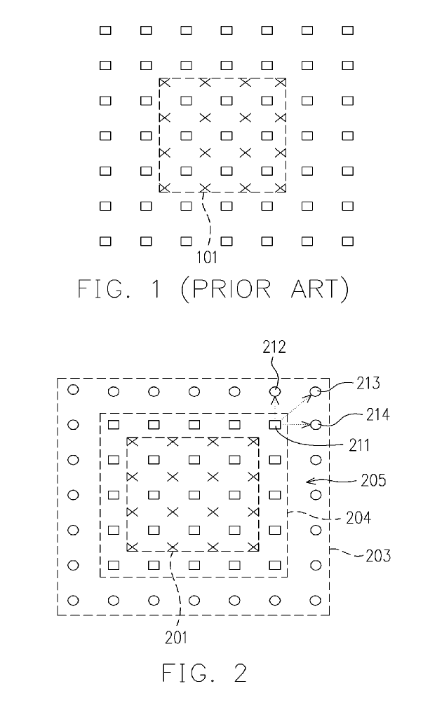

FIG. 2 is a diagram showing an interpolation method according to one embodiment of the present invention. The example in FIG. 2 is about generating a reference block 201 for a right down (2.5, 2.5) motion vector for a current block having a 4×4 extension. If the interpolation filter has a length of 4, the conventional method demands the loading of a 7×7 data range 203. In the present invention, only part of the data range 203 is loaded.

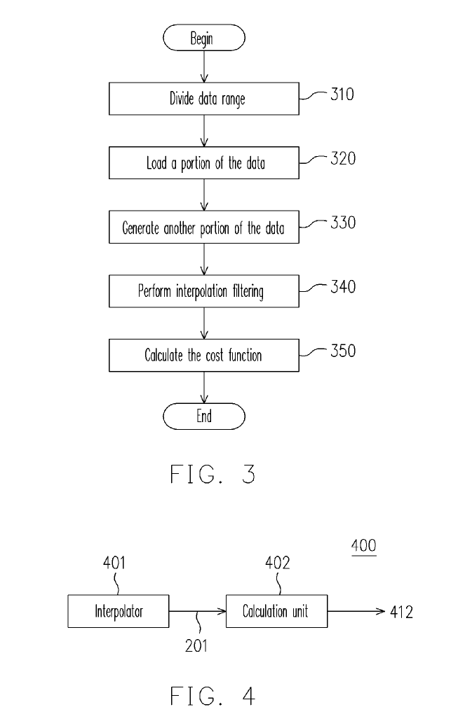

FIG. 3 is a flowchart showing an interpolation method and a method of calculating a cost function according to one embodiment of the present invention. First, in step 310, the data range 203 needed for the interpolation filtering is divided into a 5×5 loaded range 204 and a speculation range 205 occupying the remaining part. The loaded range 204 as shown in FIG. 2 is a 5×5 square disposed closer to the center of reference frame block 201 than the speculation range 205. Obviously, the loaded range in the present invention is not limited to the shape, location and size shown in FIG. 2. The shape of the loaded range in the present invention can be rectangular or some other forms and the location may deviate somewhat from the center of the reference frame block. Furthermore, as long as the size of the loaded range is greater than the current block (4×4 in the present embodiment) and is smaller than the data range (7×7 in the present embodiment), the memory bandwidth can be reduced while maintaining accuracy in the cost function.

After dividing up the range, step 320 is executed to load the data (the small block in FIG. 2) within the loaded range 204. Then, step 330 is executed to generate the data (indicated using a small circuit in FIG. 2) within the speculation range 205 using the data from the loaded range 204. In the present embodiment, the step 330 fills up the speculation range 205 directly using the data within the loaded range 204. More specifically, each location in the speculation range 205 will be filled using the data in the loaded range 204 closest to the aforementioned location. For example, the data in location 21 1 will fill up the three locations labeled 212 to 214 in FIG. 2.

Thereafter, in step 340, using the whole data range 203 as the input data, the interpolation filtering process is carried out to produce the interpolated reference frame block 201 (indicated by cross point in FIG. 2). Thus, the interpolation filtering according to the present embodiment is completed.

A method of calculating cost functions can also be derived from the interpolation method in the present embodiment. The main difference from the foregoing interpolation method is that the method of calculating the cost function includes an additional step. In other words, after executing the step 340, another step 350 is carried out to compare the current block with the reference frame signal 201 generated in step 340 and then compute the cost function.

In the present embodiment, the loaded range 204 is only a 5×5 block so that the required memory bandwidth is only 51% of the original 7×7 block. Because most of the data for interpolation filtering originate from the reference frame, the present embodiment can still obtain a highly accurate estimation of the reference block for the decimal motion vector. In addition, the invention also permits a compromise between the memory bandwidth and the accuracy of the reference block. For example, in the present embodiment, the loaded range 204 can be expanded to a 6×6 block so that a larger memory bandwidth is used in return for a better motion estimation quality.

Beside the foregoing interpolation method and method of calculating the cost function, the present invention also provides a cost function calculation apparatus. FIG. 4 is a block diagram of a cost function calculation apparatus according to one embodiment of the present invention. As shown in FIG. 4, the cost function calculation apparatus includes an interpolator 401 and a calculation unit 402. The interpolator 401 will divide the data range 203 for the interpolation filtering into a loaded range 204 and a speculation range 205. Then, the data within the loaded range 204 is loaded. Thereafter, the data within the loaded range 204 is used to generate the data inside the speculation range 205. Finally, using the entire data range 203 as the input data, an interpolation filtering is carried out to produce the interpolated reference frame signal 201. The calculation unit 402 will compare the current block corresponding to the interpolation filtering process with the reference frame signal 201 produced by the interpolator 401 and compute the cost function.

In summary, the critical aspect in the present invention is not loading in all the needed data for the interpolation filtering process. Only a portion of the data is loaded and the loaded portion is used to generate the remaining data. Since the amount of data loaded in is less, the memory bandwidth of the interpolation filtering process is reduced. Moreover, most of the data for the interpolation filtering process is still derived from the original reference frame. Thus, the present invention can provide accurate cost function and a high compression quality.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An interpolation method suitable for decimal motion estimation, comprising the steps of:
(a) dividing a data range needed for performing an interpolation filtering process into a loaded range and a speculation range;
(b) loading the data within the loaded range;
(c) using the data in the loaded range to generate the data within the speculation range; and
(d) using the data range as input data to perform the interpolation filtering process.

2. The interpolation method of claim 1, wherein the loaded range has a rectangular shape.

3. The interpolation method of claim 1, wherein the loaded range is greater than the current block corresponding to the interpolation filtering process and is smaller than the data range.

4. The interpolation method of claim 1, wherein the loaded range is closer to the center of the reference frame block corresponding to the interpolation filtering process than the speculation range is.

5. The interpolation method of claim 1, wherein the step (c) includes using directly the data within the loaded range to fill up the speculation range.

6. The interpolation method of claim 5, wherein the step (c) includes, for each location in the speculation range, using the data in the loaded range closest to the location to fill up the location.

7. A method of calculating cost functions suitable for decimal motion estimation, comprising the steps of:
(a) dividing a data range needed by an interpolation filtering process into a loaded range and a speculation range;
(b) loading the data within the loaded range;
(c) using the data in the loaded range to generate the data within the speculation range;
(d) using the data range as input data to perform the interpolation filtering process; and
(e) comparing a current block corresponding to the interpolation filtering process with a reference frame signal produced in step (d) to compute a cost function.

8. The cost function calculation method of claim 7, wherein the loaded range has a rectangular shape.

9. The cost function calculation method of claim 7, wherein the loaded range is larger than the current block and is smaller than the data range.

10. The cost function calculation method of claim 7, wherein the loaded range is closer to the center of the reference frame block corresponding to the interpolation filtering process than the speculation range is.

11. The cost function calculation method of claim 7, wherein the step (c) includes using directly the data within the loaded range to fill up the speculation range.

12. The cost function calculation method of claim 11, wherein the step (c) includes, for each location in the speculation range, using the data in the loaded range closest to the location to fill up the location.

13. A cost function calculation apparatus suitable for decimal motion estimation, comprising:
an interpolator for dividing a data range needed to perform an interpolation filtering process into a loaded range and a speculation range, loading the data within the loaded range, using the data in the loaded range to generate the data within the speculation range, and using the data range as input data to perform the interpolation filtering process; and
a calculation unit for comparing a current block corresponding to the interpolation filtering process with a reference frame signal produced by the interpolator to compute a cost function.

14. The cost function calculation apparatus of claim 13, wherein the loaded range has a rectangular shape.

15. The cost function calculation apparatus of claim 13, wherein the loaded range is greater than the current block and is smaller than the data range.

16. The cost function calculation apparatus of claim 13, wherein the loaded range is closer to the center of the reference frame block corresponding to the interpolation filtering process than the speculation range is.

17. The cost function calculation apparatus of claim 13, wherein the interpolator directly uses the data within the loaded range to fill up the speculation range.

18. The cost function calculation apparatus of claim 17, wherein, for each location in the speculation range, the interpolator uses the data in the loaded range closest to the location to fill up the location.
